(19) United States
(12) Patent Application Publication
(10) Pub. No.: US 2007/0052336 A1
(43) Pub. Date: Mar. 8, 2007

(54) Spark plug

(76) Inventor: Chen Chun Liao, Tainan County (TW)

Correspondence Address: BIRCH STEWART KOLASCH & BIRCH, PO BOX 747, FALLS CHURCH, VA, 22040-0747, US

(21) Appl. No.: 11/513,307

(22) Filed: Aug. 31, 2006

(30) Foreign Application Priority Data
Sep. 2, 2005 (TW) 094130040

(51) Int. Cl. H01T 13/20

(52) U.S. Cl. 313/141

(57) ABSTRACT

A spark plug provided to ignite fire and generate power for an engine, comprises an outer layer with an inner cavity and a ceramics insulator enclosing a central electrode inside the inner cavity. A gap is located between the ceramics insulator and the housing. The central electrode has a body and a head. One end of the body radically extends and forms a tip. The present invention improves ignition and fuel efficiency, thereby reducing air pollution.

This application claims priority based on a Taiwanese patent application No. 094130040 filed on Sep. 2, 2005.

### BACKGROUND OF THE INVENTION

1. Field of the Invention

The present invention relates to a spark plug. Specially, the present invention relates to a spark plug that improves the efficiency in motors.

2. Description of the Relative Art

FIG. 1 shows a prior art spark plug 1. A ceramics insulator 4 encloses a central electrode 2 to prevent a high-voltage short circuit or electric leakage. Between the ceramics insulator 4 and housing 3 there are asbestos, ceramic powder filing and copper ring, wherein the ceramics insulator 4 is inserted in the housing 3 to form a gas-proof body for preventing engine's pressure leakage. Two ring-shaped auxiliary electrodes 51 and 52 are disposed on the ceramics insulator 4 wherein the outer peripheral rim 501 of the first upper ring-shaped auxiliary electrode 51 is lower than the end of the central electrode 201. The lower peripheral rim of the ring-shaped electrode 52 is in the same height with top 301 of housing 3 in the vertical direction.

As shown in FIG. 2, triple-spark discharges x, y, and z occur in the combustion chamber 9 of the engine 7. Spark x is generated between the central-electrode 2 and the outer peripheral rim 501 of the first ring-shaped electrode 51; spark y is generated between the first ring-shaped electrode 51 and the second ring-shaped electrode; spark z is generated between the second ring-shaped electrode 52 and the housing 3. Particularly, the tapering tip of the cylindrical ceramics insulator enables spark dischargers x and y to occur in curve lines, wherein spark discharge z occurs horizontally.

However, a curviform spark discharge substantially reduces the ignition efficiency. Particularly, when the engine 7 operates at a high speed, the time for inflammable mixture entering a combustion chamber 9 is extremely short. A curviform spark discharge provided by conventional spark plug needs more time to ignite a fuel-air mixture, more than a straight line spark discharge does. It results in slow ignition and incomplete combustion. In other words, some fuel is exhausted before complete combustion; it causes not only a waste, but also air pollution.

Moreover, fuel-air and greasy filth easily get into recess 6 and effect the ignition of spark discharge z. It causes a circuit-short of the spark plug and incomplete combustion.

### SUMMARY OF THE INVENTION

The present invention relates to a spark plug, wherein all spark discharges occur along a shortest straight path.

The object of the present invention is to provide a central electrode that has a body and a conical head. The conical head radially extends from one end of the body.

Another objective of the present invention is to provide at least one rotatable auxiliary electrode for not only igniting spark discharges more efficiently, but also extending the life span of a spark plug by slowing the oxidization rate.

Another objective of the present invention is to generate at least one circular spark of 360 degrees.

Another objective of the present invention is to increase the ignition efficiency and optimize the fuel efficiency.

### BRIEF DESCRIPTION OF THE DRAWINGS

FIG. 1 is a cross-sectional view of a prior art device;

FIG. 2 shows a prior art device of FIG. 1 Igniting sparks in an engine combustion chamber;

FIG. 3a shows the first embodiment of the present invention;

FIG. 3b showing has well arranged of multi holes disposed on the inclined surface of the FIG. 3a;

FIG. 4 is a partial cross-sectional view of the first embodiment of the present invention;

FIG. 5 shows the second embodiment of the present invention;

FIG. 6 is a partial cross-sectional view of the second embodiment of the present invention;

FIG. 7 shows the third embodiment of the present invention;

FIG. 8 is a partial three-D cross-sectional view of the third embodiment of the present invention;

FIG. 9 shows the airflow when a fuel-air mixture enters the engine combustion chamber with the spark plug of FIG. 3 installed in;

FIG. 10 shows the airflow of the fuel-air mixture when an engine compresses;

FIG. 11 shows the spark plug of FIG. 5 installed in an engine combustion chamber;

FIG. 12 shows the spark plug of FIG. 7 installed in an engine combustion chamber;

FIG. 13 shows an embodiment of the present invention; and

FIG. 14 shows another embodiment of the present invention.

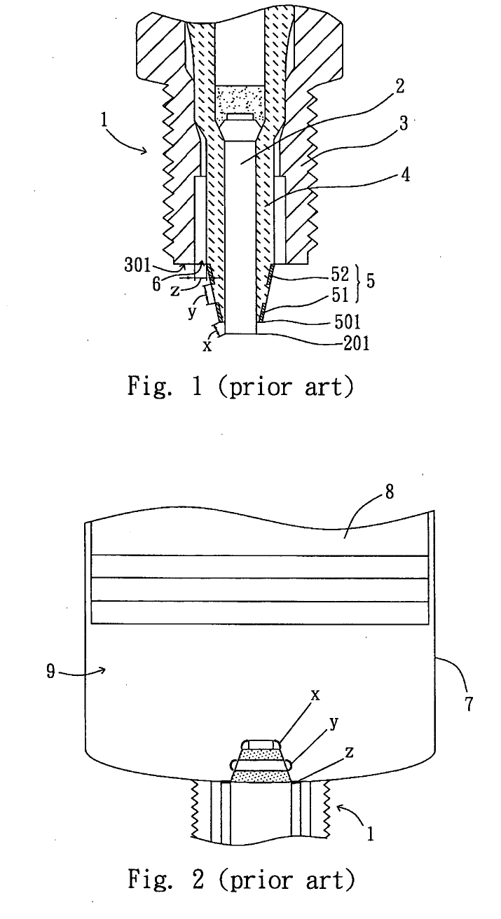

### DETAILED DESCRIPTION OF THE PREFERRED EMBODIMENT

The preferred embodiments of the present invention are illustrated hereunder with attached drawings.

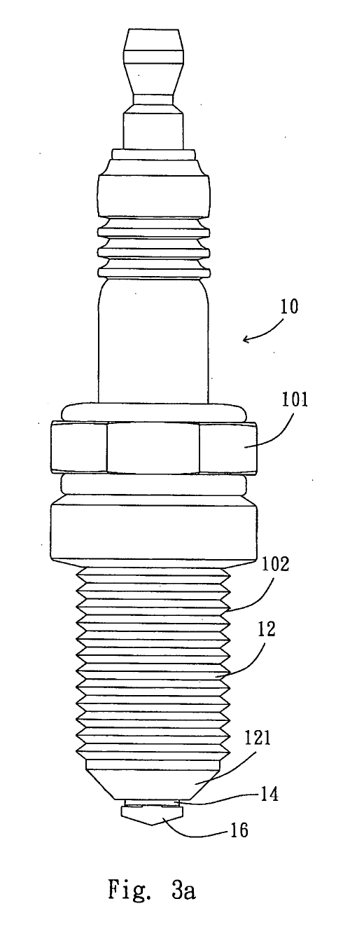

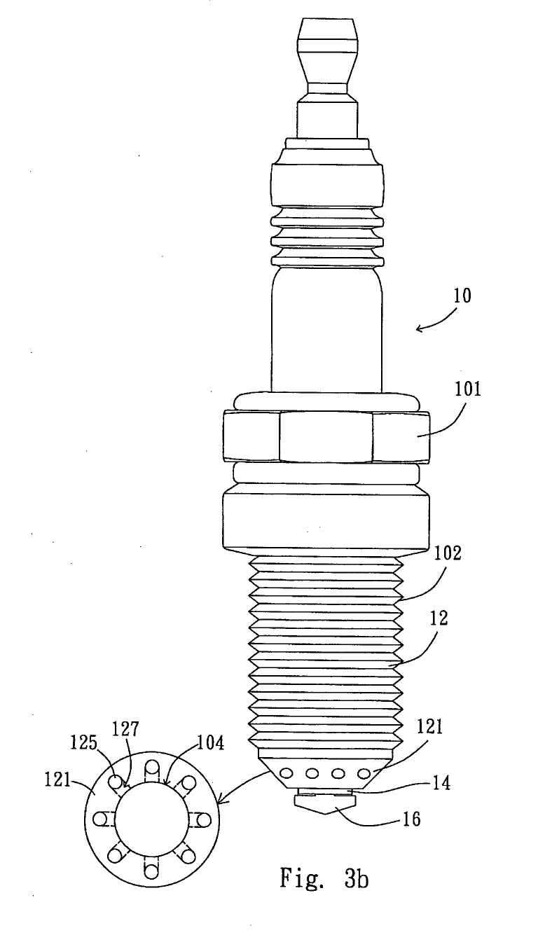

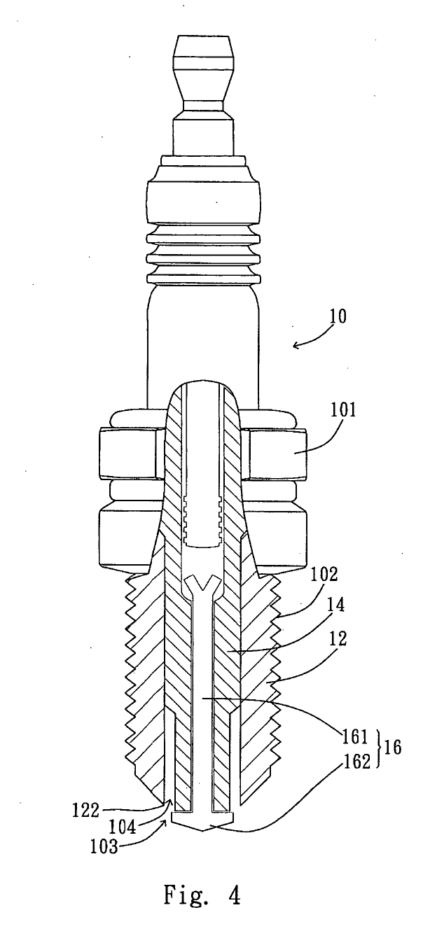

Please refer to FIG. 3a, FIG. 3b and FIG. 4, which show the first embodiment of the present invention. The spark plug 10 of the present invention comprises a housing 12, a ceramics insulator 14 and a central electrode 16. The housing 12 has an inner cavity 103 disposed within it and threads 102 on the upper part of the housing 12 for assembling into the engine block. The size of the ceramics insulator 14 varies with different pitch gauges of threads 102. The ceramics insulator 14 encloses a central electrode 16 and is disposed in the inner cavity 103. A gap 104 is formed between the inner cavity 103 and the housing 12. The central electrode 16 has a body 161 and a head 162, the head 162 radially extends from one end of the body 161, and the outer surface of the head 162 is formed with a taper. The central electrode 16 of the first embodiment is integrated formed. The head 162 preferably is conical in shape and radially extends over the ceramics insulator 14. In other words, the diameter of the head 162 is larger than the outer diameter of the ceramics insulator 14.

The end of the ceramics insulator 14, which is in contact with the head 162 of the central electrode 16, is higher than the rim 122 of housing 12. In other words, the end of the ceramics insulator 14 is exposed from the rim 122 of housing 12. The housing 12 tapers off to rim 122 and forms an inclined surface 121. The inclined surface 121 has multi designed of holes 125, and the holes 125 further have a path 127 passes through the housing 12 to the gap 104. As shown In FIG. 3b, the designed holes 125 are preferably have eight holes. But in the other embodiment, the designed holes also have at least one hole. When the fuel-air mixture to rich or the greasy filth enters into the gap 104, they can be able to escape from the gap 104 via the designed of the holes 125 and the paths 127. Hence the discharge of the spark plug 10 will not short circuit by the influence of the fuel-air mixture and will extend the spark plug 10 life-span.

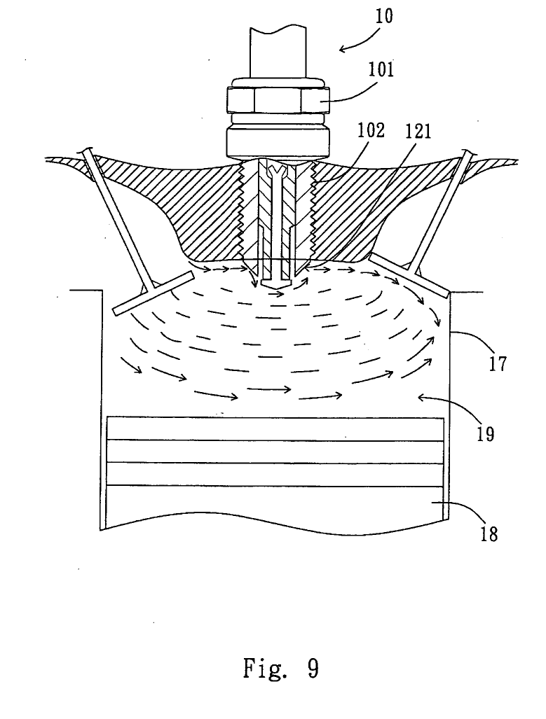

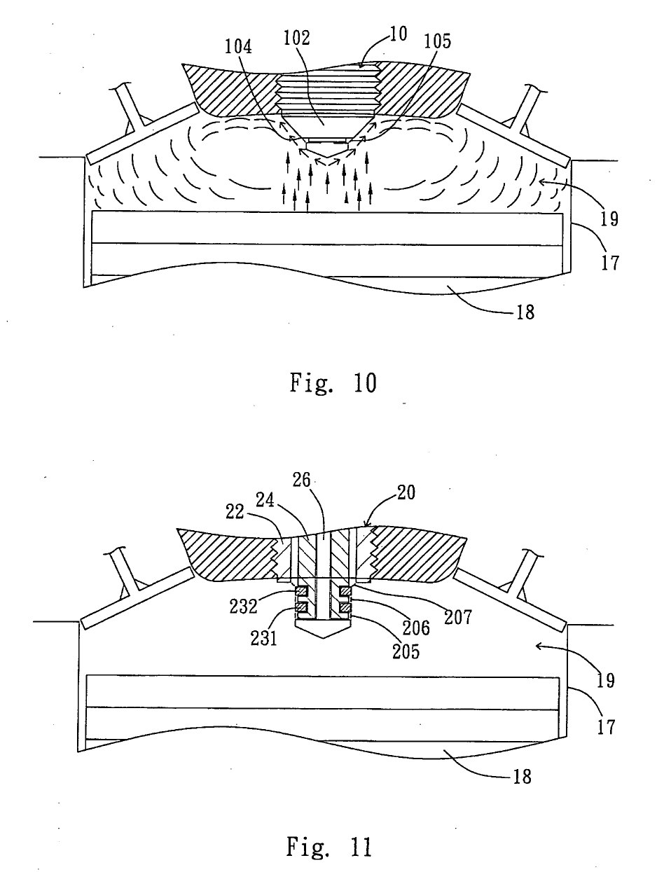

Furthermore, the inclined surface 121 helps to direct a flow direction of the fuel-air mixture. As shown in FIG. 9, the inclined surface 121 of the spark plug 10 is exposed in an engine combustion chamber 19. When fuel-air mixture enters into the engine combustion chamber 19, the inclined surface 121 directs the fuel-air mixture to contact with the spark discharge speeding up an ignition process. In this embodiment, the preferred incline angle of the inclined surface 121 is between 10 degrees to 70 degrees, wherein the most preferred incline angle is at 45 degrees. Because the 45 degrees provides the shortest travel distance to make the least energy consumption compares with all others angle of arrangement. Furthermore rim 122 and a closest portion of said central electrode 16 together define a continuous circular surface. A circular spark 105 is generated by the spark plug 10 in said continuous circular surface as shown in FIG. 10. In this embodiment, the preferred inclined angle of the circular surface 121 is similar to the inclined angle of the inclined surface 121.

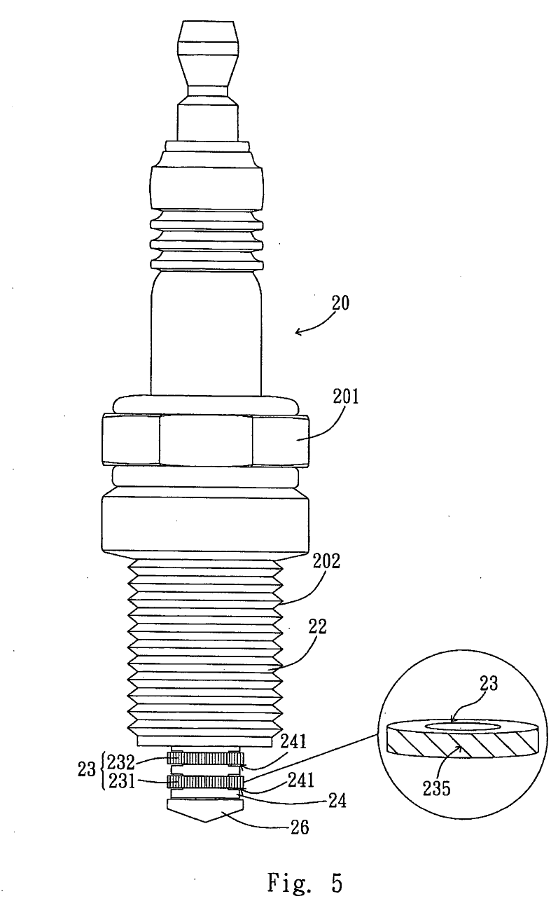

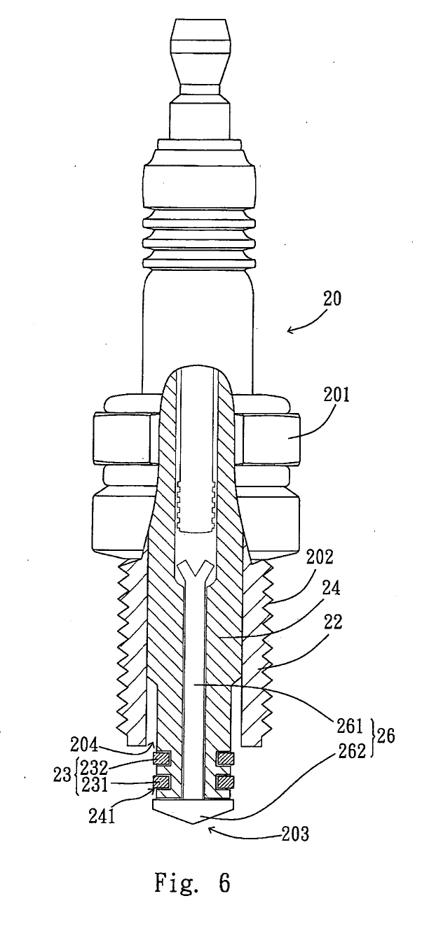

Please refer to FIG. 5 and FIG. 6, which show the second embodiment of the present invention provided to separately generate three circular sparks. The spark plug 20 comprises a housing 20, a ceramics insulator 24 and two auxiliary ring-shaped electrodes 23. Wherein the housing 20 has an inner cavity 203 disposed within it and threads 102 on the lower part of the housing 20 for assembling into the engine block. The size of the ceramics insulator 24 varies with different pitch gauges of the threads 202. The ceramics insulator 24 encloses a central electrode 26. Two depressions 241 are formed on the protruding end of the ceramics insulator 24. The ceramics insulator 24 is disposed in the inner cavity 204, and a gap 204 is formed between the housing 22 and the ceramics insulator 24. The central electrode 26 has a body 261 and a head 262. The head 262 radially extends from one end of the body 261, and the outer surface of the head 262 is preferably formed with a taper. The central electrode 26 of this embodiment is preferred to be interatedly formed, and the head 262 is preferred conical in shape.

Auxiliary ring-shaped electrodes 23 are rotatively disposed in depressions 241. The second auxiliary ring-shaped electrode 232 is exposed from the housing 22. The first and second ring-shaped electrodes 231 and 232 equally divide the portion of the ceramics insulator 24 exposed from the housing. Therefore spans of the three circular sparks are substantially identical. The conical head 262 radially extends over the lower end of the ceramics insulator 24. In other words, the diameter of the base of the head 262 is larger than the outer diameter of the lower end of the ceramics insulator 24. Furthermore, the diameters of the auxiliary ring-shaped electrodes 231 and 232 are larger than the outer diameter of the lower end of the ceramics insulator 24.

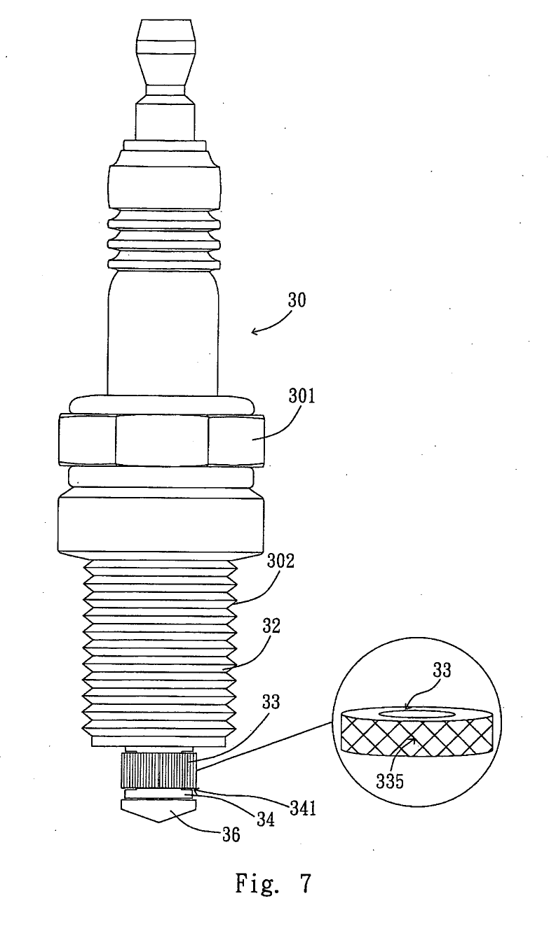

In addition, the two auxiliary ring-shaped electrodes 231 and 232 reduce an accumulation of greasy filth and thereby extend the useful life of the spark plug 20. During the operation of the engine 17, such as the reciprocating motion of the piston 18, the fuel-air mixture enters into the engine combustion chamber 19 rapidly, and the operation creates a powerful airflow. The powerful airflow forces the auxiliary ring-shaped electrodes 231 and 232 to rotate around the axis of the ceramics insulator 24. The centrifugal force of the rotation throws the greasy filth away from the auxiliary ring-shaped electrodes 231 and 232 to improve the durability of the spark plug 20. Furthermore, the auxiliary ring-shaped electrodes 23 have a pattern 235 on its surface to form an increased effective area for receiving wind. Therefore, the increased effective area makes the rotation of the two auxiliary ring-shaped electrodes 231 and 232 easier. The pattern 235 includes a straight pattern, twill pattern 235 and cross twill 335 (as shown in FIG. 5 and FIG. 7). The pattern is designed according to different demand.

The occurrences of the spark discharges of this embodiment are illustrated hereinafter accompanying with FIG. 11. The first and second auxiliary ring-shaped electrodes 231 and 232 generate three circular sparks, the first circular spark C 205, the second circular spark D 206 and the third circular spark E 207. According to a point discharge phenomenon of electricity, circular spark C 205 occurs along a shortest path between the lower peripheral rim of electrode 231 and the central electrode 26. Circular spark D 206 occurs along the shortest path between the first electrode 231 and the second electrode 232. Circular spark E 207 occurs along a shortest path between the upper peripheral rim of electrode 232 and the housing 22. As we know, the shortest path preferably intersects the horizontal with an acute angle of 45 degrees. Because the 45 degrees provides the shortest travel distance that makes the least energy consumption compares with all others angle of arrangement that shows in embodiment, however, the intersection angle may vary between 10 degrees to 70 degrees. The design of the present invention enables a faster ignition, increases fuel efficiency and optimizes the ignition efficiency, thereby reduces the air pollution.

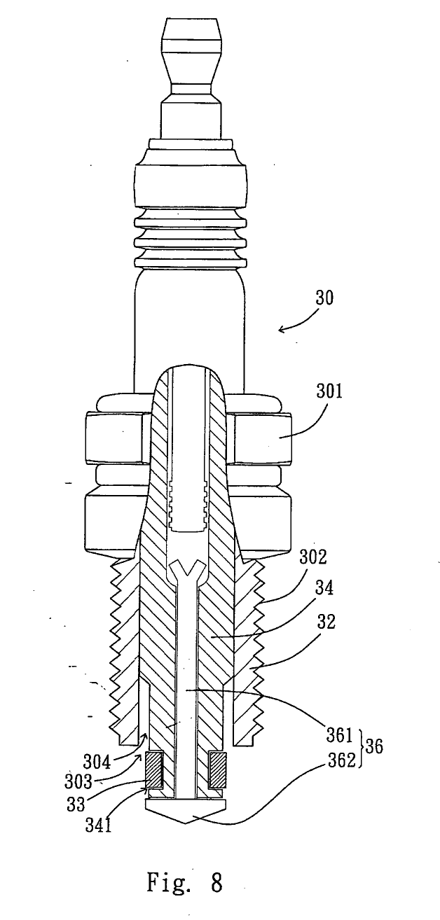

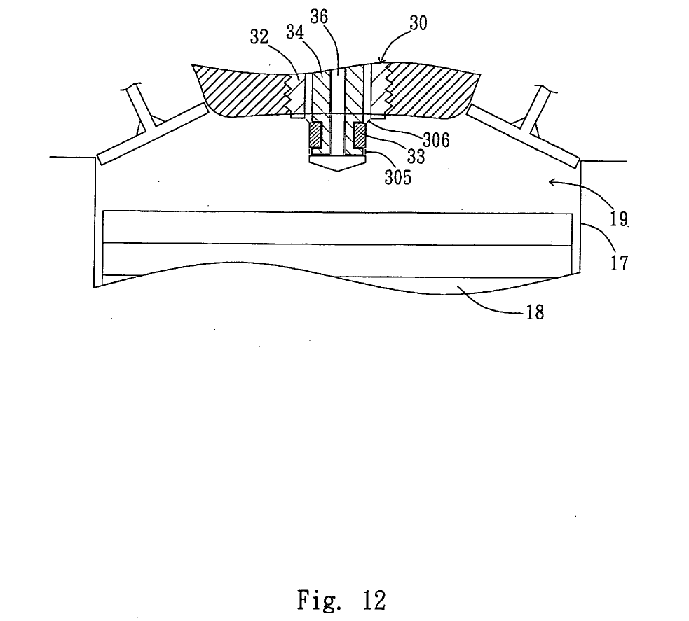

A third embodiment of the present invention generates two circular sparks, as shown in FIG. 7 and FIG. 8. The structure of the third embodiment resembles the second embodiment; the only difference is that the third embodiment has only one auxiliary ring-shaped electrode 33. Please refer to FIG. 12; the single auxiliary electrode 33 generates two circular sparks, spark A 305 and spark B 306. Circular spark A 305 occurs along a shortest path between the lower peripheral rim of the auxiliary ring-shaped electrode 33 and the central electrode 36. Circular spark B 306 occurs along a shortest path between the upper peripheral rim of the auxiliary ring-shaped electrode 33 and the housing 32. The shortest paths mentioned above are straight lines. The shortest path where circular spark 306 occurs preferably intersects the horizontal with an acute angle of 45 degrees. In different embodiments, however, the intersection angle may vary between 10 degrees to 70 degrees.

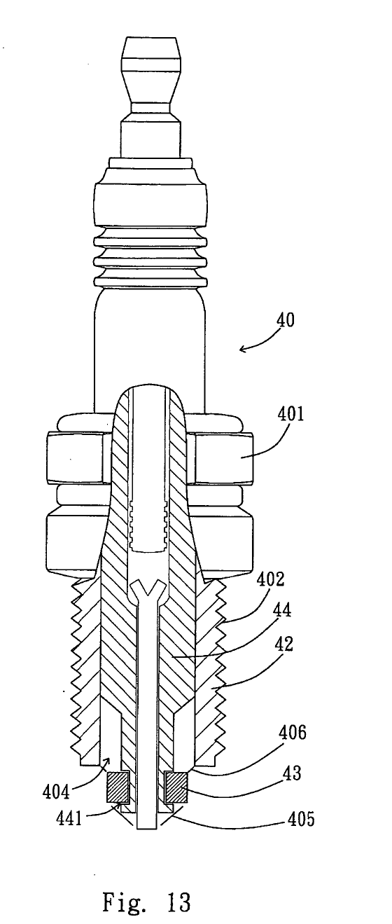

A fourth embodiment of the present invention is illustrated hereinafter accompanying with FIG. 13. The spark plug 40 comprises an electrically and thermally conductive housing 42, a ceramics insulator 44 and a single auxiliary ring-shaped electrode 43. The conductive housing 42 has an inner cavity 403 disposed within it and threads 402 on its lower part for assembling into the engine block. The size of the ceramics insulator 44 varies with different pitch gauges provided by threads 402. The central electrode 46 disposed inside the inner cavity 403 of the ceramics insulator 44. The depression 441 is formed on the protruding end of the ceramics insulator 44 and a gap 204 is formed between the housing 42 and the ceramics insulator 44. Auxiliary ring-shaped electrode 43 is rotatively disposed in depression 441. Wherein the auxiliary ring-shaped electrode 43 is exposed from the housing 42.

In this embodiment, the central electrode 46 has a stick shape. Auxiliary ring-shaped electrode 43 is rotatively disposed in depression 441. The diameter of auxiliary ring-shaped electrode 43 is larger than the outer diameter of the lower end of the ceramics insulator 44 for a quicker ignition between the auxiliary electrode 43 and housing 42 and between electrode 43 and the central auxiliary electrode 46.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims. This embodiment provides two circular sparks 405 and 406 as shown in FIG. 13. The two circular sparks respectively intersect the horizontal with specific angles, and the range of the specific angles is between 10 degrees to 70 degrees. Similar to the first three embodiments mentioned above, the most preferred angle is at 45 degrees.

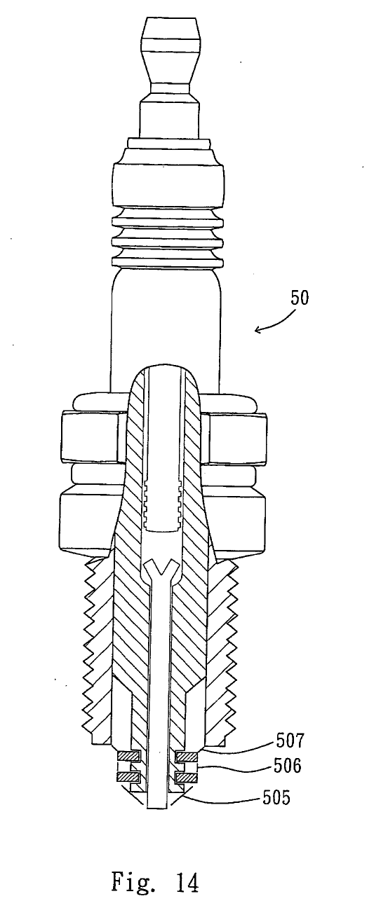

Another embodiment shown in FIG. 14 comes from the fourth embodiment by adding one auxiliary ring-shaped electrode. The central electrode is in a stick shape, the spark plug 50 generates three 360-degree circular sparks 505, 506 and 507. Otherwise the features of this embodiment are similar to the second and the forth embodiments. This embodiment may include either single auxiliary 43 or two auxiliary electrodes 53. Each of the auxiliary electrodes may have a pattern on its surface.

The preferred material of the auxiliary electrodes of the embodiment 1˜5 is “Ti alloy”, and the preferred material of the central electrodes is “Ni—Fe alloy” or other innovative material. The housing is made of Fe or other electrically or thermally conductive material.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A spark plug for use with a combustion chamber, comprising:
a housing having an inner cavity; and
a ceramics insulator enclosing a central electrode disposed in said inner cavity, wherein a gap is formed between said central electrode and said housing;
wherein said central electrode includes a body and a head, said head radially extends from one end of said body, and the outer surface of said head is formed with a taper.

2. The spark plug of claim 1, wherein a rim of said ceramics insulator protrudes out from said housing.

3. The spark plug of the claim 1, wherein said head of said central electrode extends over said ceramics insulator.

4. The spark plug of claim 1, wherein said body and said head are integrated formed.

5. The spark plug of claim 1, wherein the end of said housing has an inclined surface, said inclined surface has a rim.

6. The spark plug of claim 5, wherein said inclined surface further has a multi designed of holes.

7. The spark plug of claim 5, wherein said inclined surface is completely exposed in said combustion chamber.

8. The spark plug of claim 5, wherein said rim and a closest portion of said center electrode together define a continuous circular surface, a circular spark is generated in said continuous surface.

9. The spark plug of claim 8, wherein said continuous surface intersects the horizontal with an acute angle of 45 degrees.

10. A spark plug, comprising:
a housing having an inner cavity;
a ceramics insulator enclosing a central electrode disposed in said inner cavity, said ceramics insulator forming at least one depression disposed on an outer surface of said ceramics insulator, wherein a gap is formed between said central electrode and said housing; and
at least one auxiliary electrode formed into a ring shape and disposed in said depression;
wherein said central electrode includes a body and a head, said head radially extends from one end of said body, and the outer surface of said head is formed with a taper.

11. The spark plug of claim 10, wherein said auxiliary electrode is rotatively disposed in said depression.

12. The spark plug of claim 10, wherein said auxiliary electrode is exposed from said housing.

13. The spark plug of claim 10, wherein said head of said central electrode extends over said ceramics insulator.

14. The spark plug of claim 10, wherein said body and said head are integrated formed.

15. The spark plug of claim 10, wherein an outer diameter of said auxiliary electrode is larger than an outer diameter of said ceramics insulator.

16. The spark plug of claim 10, wherein a surface of said auxiliary electrode has at least one pattern, said pattern forms an increasing effective area for receiving wind.

17. The spark plug of claim 10, wherein said auxiliary electrode is made of Ti alloy.

18. The spark plug of claim 10, wherein said auxiliary electrode includes a single auxiliary electrode for separately generating A and B spark discharges.

19. The spark plug of claim 18, wherein said A spark discharge occurs along a shortest path between an upper peripheral rim of said single auxiliary electrode and said central electrode.

20. The spark plug of claim 19, wherein said shortest path is substantially a straight line.

21. The spark plug of claim 18, wherein said B spark discharge occurs along a shortest path between lower peripheral rim of said single auxiliary electrode and said housing.

22. The spark plug of claim 21, wherein said shortest path intersects the horizontal with an acute angle of 45 degrees.

23. The spark plug of claim 10, wherein said at least one auxiliary electrodes includes a first auxiliary electrode and a second auxiliary electrode for separately generating C, D and E spark discharges.

24. The spark plug of claim 23, wherein said C spark discharge occurs along a shortest path between said first auxiliary electrode and said housing.

25. The spark plug of claim 23, wherein said D spark discharge occurs along a shortest path between said first auxiliary electrode and said second auxiliary electrode.

26. The spark plug of claim 25, wherein said shortest path is substantially a straight line.

27. The spark plug of claim 23, wherein said E spark discharge occurs along a shortest path between the lower peripheral rim of said second auxiliary electrode and said housing.

28. The spark plug of claim 27, wherein said shortest path intersects the horizontal with an acute angle of 45 degrees.
